(19) United States
(12) Patent Application Publication
(10) Pub. No.: US 2020/0059631 A1
(43) Pub. Date: Feb. 20, 2020

(54) CONTROL APPARATUS, CONTROL METHOD, PROGRAM, AND PROJECTION SYSTEM

(71) Applicant: SONY CORPORATION, TOKYO (JP)

(72) Inventors: MASAO KONDO, KANAGAWA (JP); SEIJI SUZUKI, KANAGAWA (JP); YUSUKE TSUJITA, KANAGAWA (JP); HIROTAKA TAKO, KANAGAWA (JP); YOSHIHITO OHKI, TOKYO (JP); YOHEI NAKAJIMA, KANAGAWA (JP); HIROSHI NAKAYAMA, TOKYO (JP); YOSHIYASU KUBOTA, KANAGAWA (JP); TAICHI NOKUO, TOKYO (JP); DAISUKE SHIONO, TOKYO (JP); MIHO YAMADA, SAITAMA (JP); MASANORI MATSUSHIMA, TOKYO (JP); KENICHI YAMAURA, NAGANO (JP)

(21) Appl. No.: 16/486,064

(22) PCT Filed: Feb. 9, 2018
(86) PCT No.: PCT/JP2018/004569

§ 371 Date: Aug. 14, 2019

(30) Foreign Application Priority Data
Feb. 24, 2017 (JP) 2017-033510

(51) Int. Cl. H04N 9/31; G06T 7/50; G06T 7/70; G06F 3/16

(52) U.S. Cl. CPC H04N 9/31; G06F 3/165; G06T 7/70; G06T 7/50

(57) ABSTRACT

The present technology relates to a control apparatus, a control method, a program, and a projection system capable of conveying information in space more intuitively. The control apparatus according to one aspect of the present technology is an apparatus that acquires space sensing data regarding an object in a space obtained by sensing the space, acquires external environment data obtained by sensing an external environment, determines an image corresponding to the object on the basis of the space sensing data, and controls to project the image to which an effect corresponding to the external environment data has been added, onto the space. The present technology can be applied to a system that controls to project an image from a projector and presents information.

### TECHNICAL FIELD

The present technology relates to a control apparatus, a control method, a program, and a projection system, and more particularly relates to a control apparatus, a control method, a program, and a projection system capable of conveying information in space more intuitively.

### BACKGROUND ART

In recent years, space rendering using a projector has often been performed. CG images are projected onto not only buildings but also furniture, daily necessities, and the like as projection surfaces, making it possible to perform extraordinary renderings.

### CITATION LIST

### Patent Document

Patent Document 1: Japanese Patent Application Laid-Open No. 2016-162142

### SUMMARY OF THE INVENTION

### Problems to be Solved by the Invention

As described above, it is possible to use a projector to transmit information. However, projected information using a simple text, image, or the like might be apart from atmosphere of an actual room, which might cause unnaturalness in some cases.

The present technology has been made in view of this situation, and aims to enable transmission of information in space more intuitively.

### Solutions to Problems

A control apparatus according to one aspect of the present technology includes: a space sensing data acquisition unit that acquires space sensing data regarding an object in a space obtained by sensing the space; an external environment data acquisition unit that acquires external environment data obtained by sensing an external environment; and a processing unit that determines an image corresponding to the object on the basis of the space sensing data and controls to project the image to which an effect corresponding to the external environment data has been added, onto the space.

The processing unit can control to change the image following the external environment data.

The space sensing data is imaging data obtained on the basis of image capturing by a camera, and the processing unit can analyze the imaging data to identify a shape of the object, and can control to project the image corresponding to the shape of the object onto the space.

The processing unit can analyze the imaging data to identify a position of the object, and can control to project the image representing a virtual shadow of the object onto a position in the vicinity of the object.

The external environment data acquisition unit can control to obtain the external environment data including physical quantity sensing data obtained by a physical quantity sensor that measures a physical quantity in the external environment, and the processing unit can control to project a motion simulation image of the image based on the physical quantity sensing data, as the image.

The physical quantity sensing data includes information regarding wind speed or wind direction in the external environment, the image is an image representing a virtual shadow of the object, and the processing unit can control to project an image of the virtual shadow wavering in accordance with the information regarding the wind speed or the wind direction.

The physical quantity sensing data includes information regarding vibration or sound in the external environment, the image is an image representing a virtual vibration surface of the object, and the processing unit can control to project an image of the virtual vibration surface wavering in accordance with the information regarding the vibration or the sound.

The physical quantity sensing data can be set to include at least any of information regarding wind speed, wind direction, strength of force, temperature, precipitation, air temperature, humidity, acceleration, light, sound, pressure, magnetism, or atmosphere.

The processing unit can control to project additional information related to the external environment data, onto a position in the vicinity of the image.

A sound effect control unit can be further provided to output a sound effect synchronized with the image, on the basis of the external environment data.

The external environment data acquisition unit can control to receive the external environment data transmitted from a sensor provided in a space different from the space.

The processing unit can control to identify a plurality of objects existing in the space on the basis of the space sensing data, determine a plurality of images corresponding to each of the plurality of objects, and can control to select an image to which an effect corresponding to the external environment data is to be added, among the plurality of images, on the basis of the external environment data.

In the present technology, space sensing data regarding an object in a space obtained by sensing the space is acquired, and external environment data obtained by sensing an external environment is acquired. Furthermore, an image corresponding to the object is determined on the basis of the space sensing data, and the image to which an effect corresponding to the external environment data has been added is projected onto the space.

### EFFECTS OF THE INVENTION

According to the present technology, information can be more intuitively transmitted in space.

Note that effects described herein are non-restricting. The effects may be any of effects described in the present disclosure.

### BRIEF DESCRIPTION OF DRAWINGS

FIG. 1 is a view illustrating an example of a use state of a projection system.

FIG. 2 is a block diagram illustrating a configuration example of the projection system.

FIG. 3 is a view illustrating an example of generation of a shadow image.

FIG. 4 is a view illustrating a display example of a hypothetical shadow.

FIG. 5 is a view illustrating an example of additional information.

FIG. 6 is a block diagram illustrating a hardware configuration example of a control apparatus.

FIG. 7 is a block diagram illustrating a functional configuration example of the control apparatus.

FIG. 8 is a flowchart illustrating control processing of the control apparatus.

FIG. 9 is a view illustrating another example of a use state of the projection system.

FIG. 10 is a view illustrating an example of arrangement of speakers.

FIG. 11 is a view illustrating an image of a change in a ripple image.

FIG. 12 is a flowchart illustrating control processing of the control apparatus.

FIG. 13 is a view illustrating a use example of the projection system in FIG. 9.

FIG. 14 is a diagram illustrating a functional configuration example of the projection system.

FIG. 15 is a diagram illustrating a functional configuration example of the projection system.

FIG. 16 is a block diagram illustrating a configuration example of a computer.

### MODE FOR CARRYING OUT THE INVENTION

Hereinafter, embodiments of the present technology will be described. Description will be presented in the following order.

1. First embodiment (example of presenting information by shadow image of object)

1-1. Configuration example of projection system

1-2. Shadow image

2. Configuration example and operation of control apparatus

2-1. Configuration of control apparatus

2-2. Operation of control apparatus

3. Modification

4. Second embodiment (example of presenting information by ripple image)

4-1. Configuration example of projection system

4-2. Operation of control apparatus

5. Modification

### First Embodiment (Example of Presenting Information by Shadow Image of Object)

<Configuration Example of Projection System>

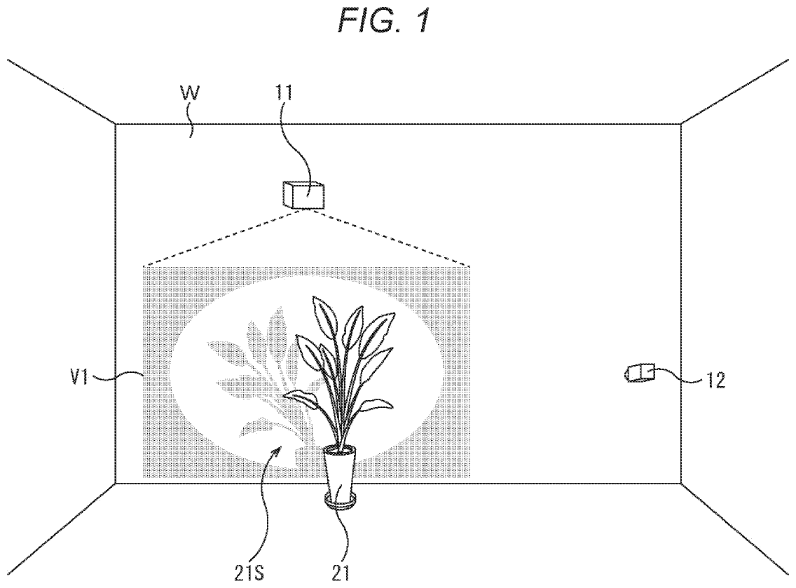

FIG. 1 is a view illustrating an example of a use state of a projection system according to an embodiment of the present technology.

The projection system of FIG. 1 is used in a public organization building, a store, or a private house room, for example, and projects an image on a wall surface to present information to surrounding people. FIG. 1 illustrates a private house room.

At an upper portion of a wall surface W, a projector 11 is installed with its light emitting direction facing to the wall surface W. Furthermore, in a same room as the room where the projector 11 is installed, a camera 12 is installed at a predetermined position in the room with its angle of view being adjusted to have a range including a projection surface of the projector 11 as an image capturing range. The camera 12 may include various sensors such as an RGB image sensor and a depth sensor.

The projection system of FIG. 1 may be used outdoors. Furthermore, the projection surface of the projector 11 may use various flat surfaces such as a floor surface or a top of a table, instead of the wall surface W. Various surfaces such as a surface of a car or a surface of a chair may be used as the projection surface, instead of a flat surface. The installation positions of the projector 11 and the camera 12 are appropriately changed in accordance with the position of the projection surface.

In the projection system of FIG. 1, a house plant 21 having leaves attached to the ends of long stems is placed at a position close to the wall surface W. Furthermore, on the wall surface W at a position near the house plant 21 (for example, in a region of the wall surface W within a predetermined distance from the position of the house plant 21), a shadow image V1 being an image representing the shadow of the house plant 21 is projected. In FIG. 1, a shadow 21S of the house plant 21 included in the shadow image V1 is a hypothetical (virtual) shadow projected by the projector 11, rather than an actual shadow of the house plant 21.

The shadow image V1 is generated by a control apparatus provided at a predetermined position on the basis of an image captured by the camera 12, and is then projected by the projector 11 under the control of the control apparatus.

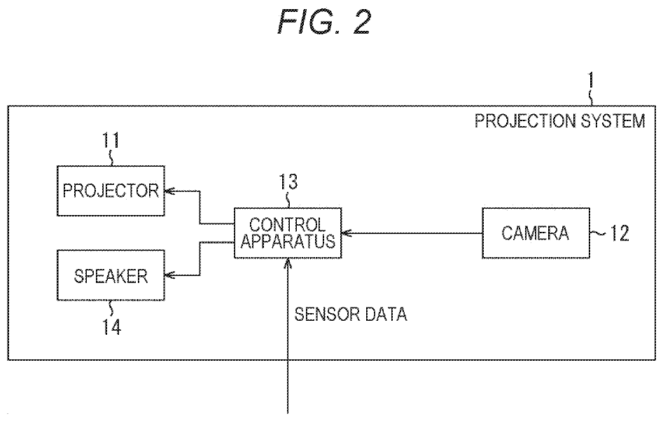

That is, as illustrated in FIG. 2, a projection system 1 as the projection system of FIG. 1 includes the projector 11, the camera 12, a control apparatus 13, and a speaker 14. The speaker 14 that outputs a sound effect synchronized with the shadow image V1 projected by the projector 11 is also provided at a predetermined position in the room.

Transmission and reception of information between the control apparatus 13 and each of the projector 11, the camera 12, and the speaker 14 is performed by wired communication or wireless communication using a predetermined standard such as wireless local area network (LAN) or Bluetooth (registered trademark).

The control apparatus 13 receives inputs, at predetermined period, of detection results from various sensors including an air temperature sensor, a humidity sensor, a wind speed sensor, an acceleration sensor, a motion sensor, an optical sensor (including an image sensor corresponding to visible light or non-visible light), a sound sensor (microphone), pressure sensor, a magnetic sensor, or an atmospheric sensor. Detection results of other sensors such as a rainfall sensor, a vibration sensor, or a biological sensor attached to a human body may be input to the control apparatus 13 as a sensing result of the external environment.

The sensor that detects such various types of external environment is provided in a space different from the space where the projector 11 and the camera 12 are installed, for example. For example, the sensor transmits sensing result data, for example, sensor data representing a predetermined physical quantity obtained by sensing a physical quantity, via wireless communication or the like. Sensor data (physical quantity sensing data) includes at least any of information regarding wind speed, wind direction, strength of force, temperature, precipitation, air temperature, humidity, acceleration, light, sound, pressure, magnetism, and atmosphere.

Hereinafter, a case where a detection result obtained by a wind speed sensor installed outdoors, that is, outside the room including the projector 11 or the like, is input will be mainly described. The sensor data transmitted by the wind speed sensor represents the wind speed and wind direction at a place where the wind speed sensor is installed.

<Shadow Image>

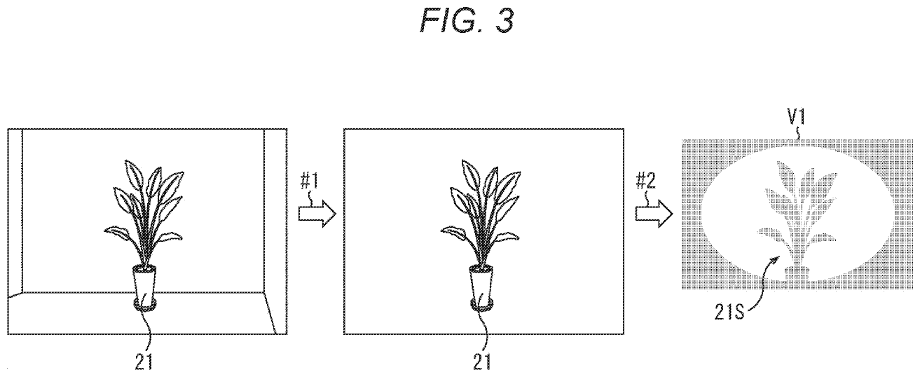

FIG. 3 is a view illustrating an example of generation of the shadow image V1.

An image illustrated at a left end of FIG. 3 is an image captured by the camera 12. The image captured by the camera 12 includes the house plant 21 disposed near the wall surface W.

The control apparatus 13 analyzes such an image and thereby recognizes the house plant 21 captured in the image, and then, extracts a region of the house plant 21 as indicated by the direction of arrow #1. The control apparatus 13 includes recognition data for recognizing various objects disposed in real space. Using the recognition data, for example, a pot portion, a stem portion and a leave portions are separately recognized.

The control apparatus 13 identifies the shape of the house plant 21 and the position where the house plant 21 is placed, and generates the shadow image V1 as indicated by the direction of arrow #2. In the example of FIG. 3, the shadow image V1 is an image including a shadow 21S, being an image of a hypothetical shadow of the house plant 21, disposed inside a high-luminance horizontally elongated oval.

The size of the shadow 21S in the shadow image V1 is determined on the basis of the range of the house plant 21 with respect to the image captured by the camera 12. The size of the shadow 21S being a hypothetical shadow is determined to have a same size as the actual shadow size of the house plant 21, for example.

Furthermore, the arrangement position of the shadow 21S is obtained, for example, on the basis of a relationship between the position of the house plant 21 and a position of a virtual light source. The light source position is virtually set on the basis of the relationship between the position of the house plant 21 being a real object and the position of the wall surface W being a projection surface.

The control apparatus 13 simulates the movement of the shadow 21S having its shape or the like identified in this manner on the basis of the wind speed and wind direction detected by the wind speed sensor, and generates the shadow image V1 in which the shadow 21S is wavering (changing) together with the wind.

The waver of the shadow 21S in the shadow image V1 is updated in real time so as to follow the detection result by the wind speed sensor. The state of the shadow 21S being inclined in the shadow image V1 of FIG. 1 indicates that the shadow is wavering in accordance with the latest detection result obtained by the wind speed sensor.

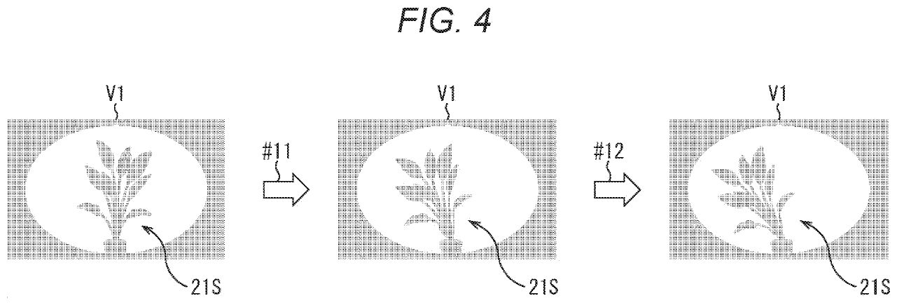

FIG. 4 is a view illustrating a display example of the shadow 21S.

In a case where the wind speed is detected as 0 m/s at a certain timing, the shadow image V1 including the shadow 21S having substantially no waver is projected as illustrated at the left end of FIG. 4. For example, the shadow 21S is displayed with a slight motion so as to express the waver of a plant in nature.

Furthermore, in a case where the wind speed is detected as 5 m/s, the shadow image V1 including the shadow 21S wavering with a predetermined magnitude is projected so as to express the wind speed of 5 m/s and the wind direction, as illustrated by the direction of arrow #11. In a case where the pot portion, the stem portion, and the leaf portion are recognized separately as described above, portions above the pot portion would move and projected with no movement of the pot portion.

In a case where the wind speed is detected as 8 m/s, the shadow image V1 including the shadow 21S that wavers more than in a case where the wind speed is detected as 5 m/s is projected so as to express the wind speed of 8 m/s and the wind direction, as indicated by the direction of arrow #12.

In this manner, the projection system 1 projects a hypothetical shadow that looks like the actual shadow of the real object, as a visual effect at a position corresponding to the real object (for example, in the vicinity of the real object), so that outdoor wind conditions can be presented by the movement of the hypothetical shadows. Hypothetical shadows would move differently from the actual shadow movement of the real object in the room appropriately.

Information is presented in the form of a hypothetical shadow image representing the shadow of an object actually existing in a room, making it possible to present information in a natural manner. For example, in the case of simply projecting a number representing the wind speed, it might not be in harmony with an object placed in a room. However, it is possible to continue to present the wind speed in a state of being blended in space. Because of use of a real thing in the room, it would not hinder harmonization with the space even when the shadow is reflected on the wall surface.

Furthermore, since the hypothetical shadow is projected in a size corresponding to the actual size of the object, the movement can intuitively convey the strength of the wind.

It is also allowable to output a sound effect representing the wind sound from the speaker 14 in synchronization with the projection of the shadow image V1. By changing the sound effects according to the strength of the wind, it would be possible to convey the strength of the wind more intuitively.

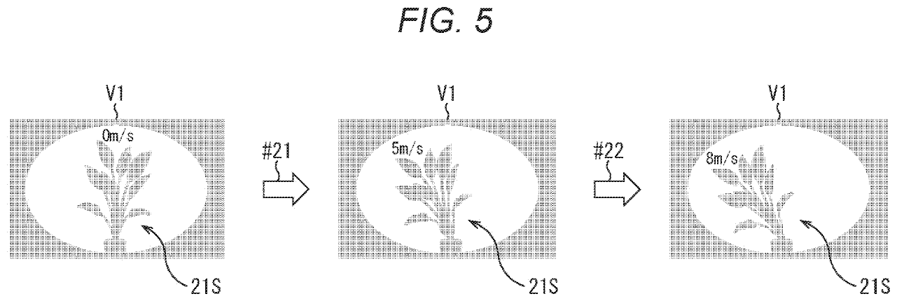

FIG. 5 is a view illustrating an example of the additional information.

As illustrated in FIG. 5, it is also possible to arrange information such as a numeral representing the wind speed as additional information in the vicinity of the shadow 21S (for example, the region of the wall surface W within a predetermined distance from the position of the shadow 21S).

In the shadow image V1 at the left end of FIG. 5, additional information of “0 m/s” is disposed above the shadow S21. Furthermore, in the shadow image V1 indicated by the direction of arrow #21, additional information of “5 m/s” is shifted more leftward than the case of the wind speed of 0 m/s, in accordance with the movement of the shadow S21. In the shadow image V1 indicated by the direction of arrow #22, additional information of “8 m/s” is shifted further leftward than the case of the wind speed of 5 m/s, in accordance with the movement of the shadow S21.

In this manner, by moving the display position of the additional information, the shadow image V1 is projected that maintains the relationship between the display position of the additional information and the position of the shadow of the leaf near the additional information. This allows the additional information to appear to waver like the shadow 21S, making it possible to intuitively convey the relevance between the shadow 21S and the waver of the additional information (meaning of the waver of the shadow 21S).

Information presented as the additional information is not limited to the wind speed, and may be the wind direction, or may be information indicating the place having the wind strength. The information presented as the additional information may be any information as long as the information is related to the detection result obtained by the sensor.

Processing of the control apparatus 13 that presents information by hypothetical shadows of an object actually existing in the room in this manner will be described later with reference to the flowchart.

### Configuration Example and Operation of Control Apparatus

<Configuration of Control Apparatus>

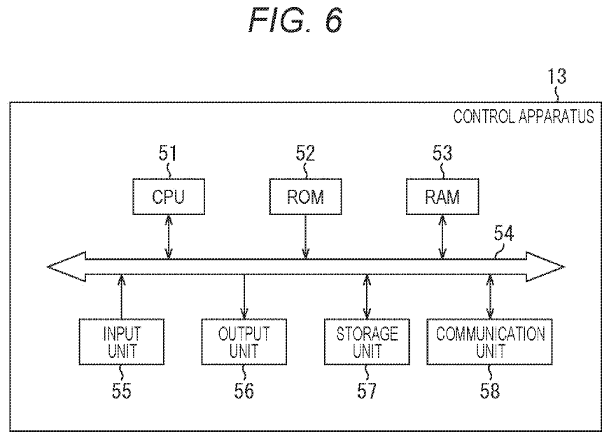

FIG. 6 is a block diagram illustrating a hardware configuration example of the control apparatus 13.

As illustrated in FIG. 6, the control apparatus 13 includes a CPU 51, a ROM 52, a RAM 53, an input unit 55, an output unit 56, a storage unit 57, and a communication unit 58, interconnected via a bus 54.

The central processing unit (CPU) 51 executes a program stored in the read only memory (ROM) 52 on the random access memory (RAM) 53, for example, so as to control the entire operation of the control apparatus 13.

The input unit 55 includes a keyboard, a mouse, or the like, and receives operation by an administrator of the projection system 1.

The output unit 56 includes a display, a speaker (not illustrated), and the like. A signal of the shadow image V1 or a signal of the sound effect may be output from the output unit 56 rather than from the communication unit 58. In this case, the output unit 56 functions as an interface for outputting a video signal of the shadow image V1 and an audio signal for sound effects.

The storage unit 57 includes a hard disk, a flash memory, or the like. The storage unit 57 stores various types of information such as a program executed by the CPU 51, data used to generate the shadow image V1 or sound effect data.

The communication unit 58 performs wired or wireless communication with the projector 11, the camera 12, and the speaker 14. For example, the communication unit 58 receives image data transmitted from the camera 12. Furthermore, the communication unit 58 transmits data of the shadow image V1 to the projector 11, and transmits sound effect data to the speaker 14. The communication unit 58 appropriately communicates with an external device via the Internet.

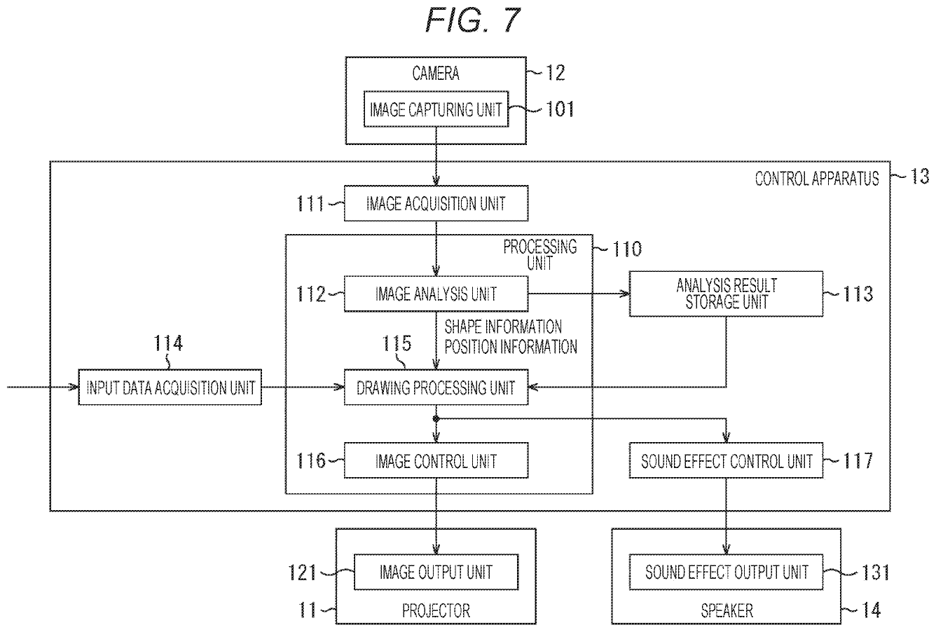

FIG. 7 is a block diagram illustrating a functional configuration example of the control apparatus 13.

At least a portion of a functional unit of the control apparatus 13 illustrated in FIG. 7 is implemented by execution of a predetermined program by the CPU 51 in FIG. 6. FIG. 7 also illustrates partial configurations of the projector 11, the camera 12 and the speaker 14.

An image capturing unit 101 of the camera 12 captures a still image, and transmits image data obtained by the image capturing to the control apparatus 13. It is allowable to control to repeat image capturing using the camera 12.

The image data may include depth data (such as a point cloud) representing a three-dimensional shape of space or other sensing data, in addition to RGB image data. The image data transmitted by the image capturing unit 101 is space sensing data obtained by sensing a space in which the camera 12 is installed.

The control apparatus 13 achieves implementation of an image acquisition unit 111, an image analysis unit 112, an analysis result storage unit 113, an input data acquisition unit 114, a drawing processing unit 115, an image control unit 116, and a sound effect control unit 117.

The image acquisition unit 111 controls the communication unit 58 and acquires an image transmitted from the camera 12. The image acquisition unit 111 functions as a space sensing data acquisition unit that acquires space sensing data transmitted by the image capturing unit 101. The image acquisition unit 111 outputs the acquired image to the image analysis unit 112.

The image analysis unit 112 analyzes the image supplied from the image acquisition unit 111, and recognizes an object such as the house plant 21 captured in the image. Furthermore, the image analysis unit 112 performs image processing and thereby identifies the shape and position of the object, and then, outputs shape information indicating the shape of the object and position information indicating the position of the object to the drawing processing unit 115. The shape information and the position information are also supplied to the analysis result storage unit 113 and stored.

The input data acquisition unit 114 controls the communication unit 58 to acquire sensor data transmitted from an external sensor. The input data acquisition unit 114 functions as an external environment data acquisition unit that acquires external environment data obtained by sensing an external environment. The input data acquisition unit 114 outputs the acquired sensor data to the drawing processing unit 115 as input data.

It is allowable to control to input information representing content of operation performed on a mobile terminal by a user such as an administrator of the projection system 1, into the control apparatus 13. In this case, the input data acquisition unit 114 controls the communication unit 58 and thereby communicates with the mobile terminal and acquires information transmitted from the mobile terminal. The input data acquisition unit 114 outputs the information transmitted from the mobile terminal to the drawing processing unit 115 as input data. The projection of an image may be controlled to be performed in response to operation on the mobile terminal.

The drawing processing unit 115 calculates and determines the shape and size of the hypothetical shadow to draw on the basis of the shape information supplied from the image analysis unit 112. Furthermore, the drawing processing unit 115 calculates and determines a drawing position of a hypothetical shadow on the basis of the position information supplied from the image analysis unit 112.

The drawing processing unit 115 performs arithmetic processing on the basis of the sensor data supplied from the input data acquisition unit 114 and thereby performs simulation of hypothetical shadow movement. For example, in the case of projecting an image of the hypothetical shadow 21S of the house plant 21, the drawing processing unit 115 performs simulation of waver in a case where the wind of the wind speed and direction indicated by the sensor data hits the leaves and branches expressed by the shape information. An effect based on sensor data is added to the hypothetical shadow to generate a shadow image.

The drawing processing unit 115 appropriately adds additional information to the hypothetical shadow generated by performing the simulation and thereby generates a shadow image. The drawing processing unit 115 outputs the generated shadow image (motion simulation image) to the image control unit 116 and the sound effect control unit 117.

The image control unit 116 controls the communication unit 58 to transmit the shadow image to the projector 11, and controls the projector 11 to project the shadow image.

In this manner, the image analysis unit 112, the drawing processing unit 115, and the image control unit 116 constitute the processing unit 110. The processing unit 110 has a function of determining the size and the position of the hypothetical shadow image corresponding to the object on the basis of the imaging data as the space sensing data, adding an effect corresponding to the sensor data as the external environment data to the image, and controlling to project the image.

The sound effect control unit 117 generates a sound effect to be output in synchronization with the shadow image, on the basis of the sensor data. For example, in a case where sensor data representing wind speed is input, the sound effect control unit 117 generates a sound effect of a wind sound. In a case where sensor data representing a rainfall amount is input, the sound effect control unit 117 generates a sound effect of rain sound. In this manner, the sound effect control unit 117 manages data of various sound effects in accordance with the type of sensor data. The sound effect control unit 117 controls the communication unit 58 to transmit a sound effect to the speaker 14 and controls to output the sound effect.

The image output unit 121 of the projector 11 judges the presence or absence of the update of the shadow image data, and receives the shadow image data transmitted from the control apparatus 13. The image output unit 121 projects a shadow image on the basis of the received data.

The sound effect output unit 131 of the speaker 14 judges the presence or absence of the update of the sound effect data, and receives the sound effect data transmitted from the control apparatus 13. The sound effect output unit 131 controls the speaker 14 to output the sound effect on the basis of the received data.

<Operation of Control Apparatus>

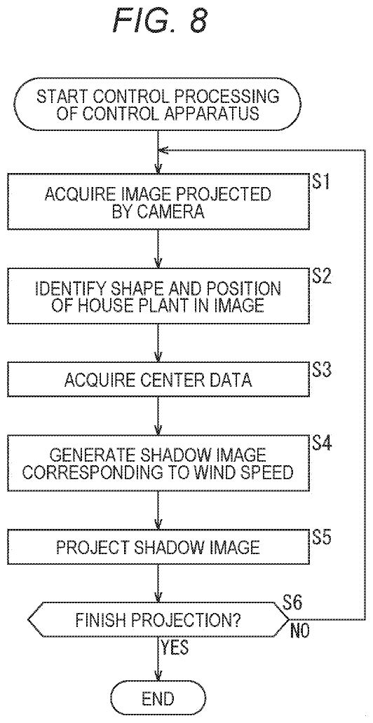

Here, control processing of the control apparatus 13 that controls the projection of the shadow image V1 will be described with reference to the flowchart in FIG. 8. The processing of FIG. 8 is started after image capturing is performed by the camera 12 and an image has been transmitted from the camera 12.

In step S1, the image acquisition unit 111 acquires an image captured by the camera 12.

In step S2, the image analysis unit 112 analyzes the image supplied from the image acquisition unit 111, and identifies the shape and position of the house plant 21 captured in the image. Shape information and position information are output from the image analysis unit 112 to the drawing processing unit 115.

In step S3, the input data acquisition unit 114 acquires sensor data transmitted from a wind speed sensor located outdoors.

In step S4, the drawing processing unit 115 specifies a drawing position of the hypothetical shadow on the basis of the shape information and the position information, and generates the shadow image V1 by performing simulation in accordance with the wind speed and the wind direction.

In step S5, the image control unit 116 transmits the shadow image V1 generated by the drawing processing unit 115 to the projector 11, and controls the projector 11 to project the shadow image V1.

In step S6, the drawing processing unit 115 determines whether or not to finish the projection of the shadow image V1. In a case where it is determined in step S6 not to finish the projection of the shadow image V1, the processing returns to step S1 and the above processing is repeated. On the basis of the newly transmitted sensor data, the shadow image V1 in which the waver of the shadow 21S has been updated is generated and projected.

In contrast, in a case where it is determined in step S6 to finish projection of the shadow image V1, the processing is finished.

By the above processing, the control apparatus 13 can intuitively convey the strength of wind detected by the wind speed sensor to a person near the projection surface.

### Modification

Example of Real Object

While the above is an exemplary case where a hypothetical shadow image of a house plant is projected, it is possible to use various real objects as a real object used for projection of the hypothetical shadow image.

For example, in a case where clothes are hung on a wall of a room, a hypothetical shadow image of the clothes may be projected on the wall. Furthermore, in a case where a book is placed on a table in a room, a hypothetical shadow image of the book may be projected on the surface of the table. It is possible to configure to use various objects such as furniture, posters affixed to walls, animals kept in a room, or people in the room.

Furthermore, as a real object, it would be possible to use an object in a space different from the space in which the projector 11 is installed, in addition to an object in a space where the projector 11 is installed like the house plant 21. For example, it is also allowable to perform recognition of remote forest trees on the basis of an image captured by the camera 12 installed in the remote forest, and to perform information presentation by projecting hypothetical shadow images of the recognized trees.

In this manner, it is also possible to configure to present various types of information such as the wind speed using hypothetical shadows of remote objects.

Example of Sensor Data

While movements are attached to the hypothetical shadow on the basis of the wind speed and the wind direction, it is also possible to add various movements in accordance with the type of sensor data.

Here, it is assumed that the real object is the house plant 21. Shadow is projected in accordance with air temperature detected by an air temperature sensor. For example, a hypothetical shadow that expresses plant growth is projected in appropriate air temperature, while a hypothetical shadow that expresses weakened plants is projected in temperatures being too hot or too cold.

Furthermore, a projected image in a case where a rainfall sensor is used would be a hypothetical shadow image indicating changing amount of droplets falling from the leaves corresponding to the rainfall amount. In a case where the earthquake sensor is used, an image to be projected would be an image of a hypothetical shadow wavering in accordance with the earthquake scale.

In this manner, various sensor data can be used as information used to obtain a hypothetical shadow movement.

Example of Hypothetical Image

While the above is an exemplary case where an image representing the shadow of a real object is projected, it is also allowable to project an image including a colored real object. In this case, an image to be projected would be an image including the house plant 21 having its color changed in accordance with the sensor data, or an image including the house plant 21 having its shape or size changed in accordance with the sensor data, for example.

### Second Embodiment (Example of Presenting Information by Ripple Image)

<Configuration Example of Projection System>

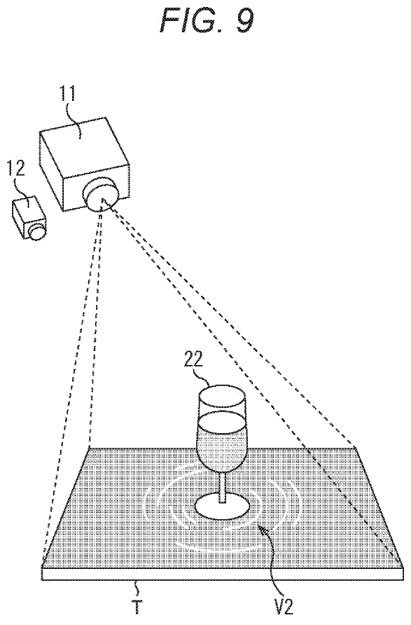

FIG. 9 is a view illustrating an example of a use state of a projection system according to another embodiment of the present technology.

FIG. 9 illustrates the projection system 1 installed in a diner such as a restaurant. A configuration same as the configuration illustrated in FIG. 9 has a same reference sign.

In the example of FIG. 9, the projector 11 and the camera 12 are installed near the ceiling of the diner. The projector 11 undergoes adjustment in its angle, focal length, or the like so that a projection surface of the projector 11 is aligned with a top surface of a table T. Furthermore, the angle of view of the camera 12 is adjusted to include the top surface of the table T in an image capturing range.

On the table T, a glass 22 containing a liquid such as wine or water is placed. An object recognized by the control apparatus 13 and to which an image used for information presentation is to be projected would be the glass 22. The control apparatus 13 also prepares recognition data for recognizing the glass.

As illustrated in FIG. 9, the projector 11 projects a ripple image V2 being an image representing a state in which a hypothetical ripple spreads from the position of the glass 22 on the top surface of the table T. That is, the control apparatus 13 identifies the shape and position of the glass 22 on the basis of the image captured by the camera 12, and draws ripples expressed by brilliance of light or the like in the position corresponding to the glass 22 (for example, a region of a predetermined range around the position of the glass 22), thereby controls to project the ripple image V2 expressing ripples spreading around the glass 22 from the projector 11.

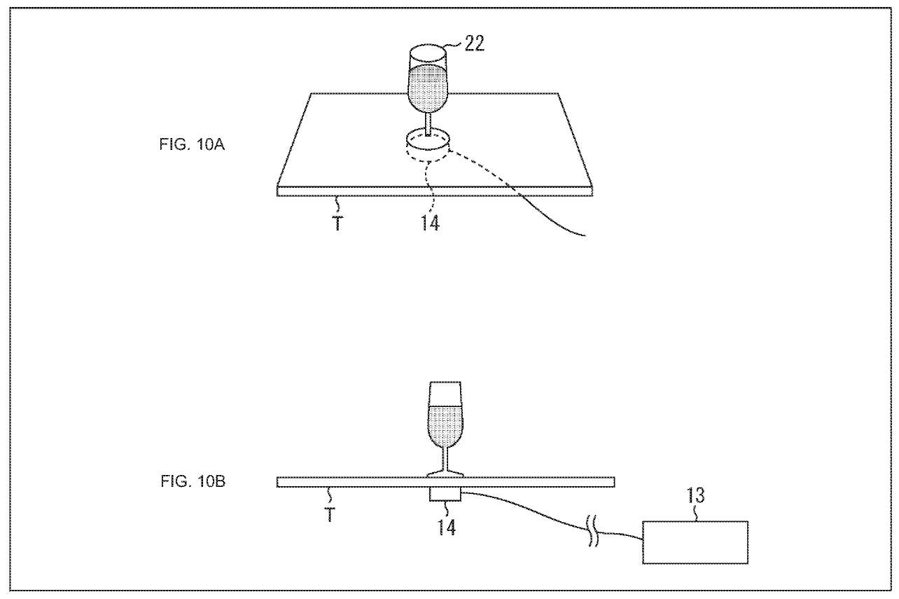

As illustrated to A and B of FIG. 10, the speaker 14 is attached to the back side of top of the table T. For example, the speaker 14 outputs a sound effect (tinkling sound or the like of glass) in synchronization with the ripple image V2 expressing ripple spread. It is possible to achieve a visual effect of allowing the liquid being poured in the glass 22 to have hypothetical spread on the entire top of the table T in response to tapping the edge of the glass 22 with a stick or the like. This would give people around the table T, such as a customer sitting in front of the table T, illusion that the water surface is shaking.

Note that while examples of A and B in FIG. 10 illustrate that the speaker 14 is provided immediately below the glass 22, the position of the speaker 14 can be any position as long as it is at the back side of the top of the table T.

The projection of the ripple image V2 and the output of the sound effects can be set at a predetermined timing such as the timing when the customer sitting in front of the table T hits the surface of the table T with a stick. The customer's behavior of hitting the surface of the table T with a stick is identified on the basis of the detection result of a sensor such as a microphone or a vibration sensor. Here, a sensor such as a microphone or a vibration sensor is used as a sensor for detecting an external environment.

That is, in this case, the ripple image V2 is an image projected in accordance with the detection result by the sensor. The ripple image V2 projected in response to tapping the surface of the table T with a stick is used by a customer to call the floor staff of a diner, for example. In this case, the ripple image V2 is an image for presenting the floor staff with information that the customer is calling.

The projection of the ripple image V2 and the output of the sound effects may be configured to be performed in response to operation on a mobile terminal performed by the floor staff of the diner. Information representing content of operation performed by the floor staff would be transmitted from the mobile terminal to the control apparatus 13. In this case, the ripple image V2 projected in accordance with the operation by the floor staff is an image presenting the customer with information that the floor staff is sending a signal.

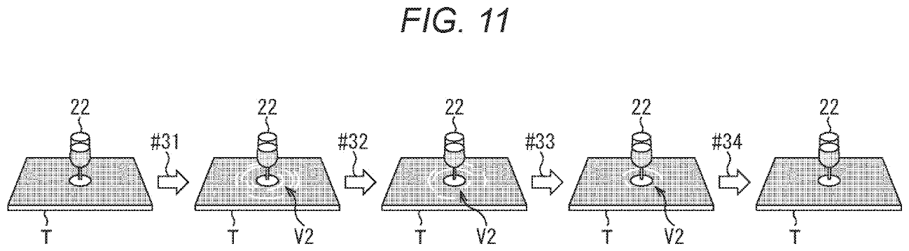

FIG. 11 is a view virtually illustrating a change in the ripple image V2.

In a case where a trigger input is detected in a state where the ripple image V2 is not projected as illustrated at the left end of FIG. 11, a sound effect is output, and projection of the ripple image V2 indicating spreading ripples is started as illustrated by the direction of arrow #31. The ripple image V2 changes in order as indicated by the direction of arrows #32 and #33. The projection of the ripple image V2 is performed for a predetermined time from the start of the projection, and is finished after lapse of the predetermined time, as indicated by the direction of arrow #34.

In this manner, when the surface of the liquid poured into the glass 22 or the top surface of the table T is assumed as a virtual vibration surface, the ripple image V2 is an image of the vibration surface that shakes in accordance with vibration detected by a vibration sensor or information of sound detected by a microphone.

<Operation of Control Apparatus>

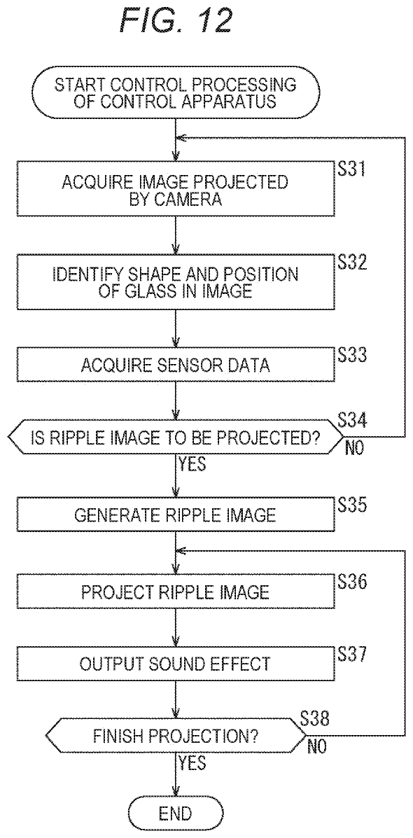

Here, control processing of the control apparatus 13 that controls the projection of the ripple image V2 will be described with reference to the flowchart in FIG. 12. The process of FIG. 12 is started when an image is transmitted from the camera 12 after image capturing by the camera 12.

In step S31, the image acquisition unit 111 acquires an image captured by the camera 12.

In step S32, the image analysis unit 112 analyzes the image supplied from the image acquisition unit 111, and identifies the shape and the position of the glass 22 captured in the image. Shape information and position information are output from the image analysis unit 112 to the drawing processing unit 115.

In step S33, the input data acquisition unit 114 acquires sensor data transmitted from a sensor such as a microphone or a vibration sensor, as input data. Furthermore, the input data acquisition unit 114 acquires data transmitted from a mobile terminal operated by the floor staff, as input data.

In step S34, the drawing processing unit 115 determines whether or not to project the ripple image V2 on the basis of the input data. In a case where it is determined in step S34 not to project the ripple image V2, the processing returns to step S31, and the above processing is repeated.

In contrast, in a case where it is determined in step S34 to project the ripple image V2, the drawing processing unit 115 specifies a drawing position of the hypothetical ripples in step S35 on the basis of the shape information and the position information, and generates the ripple image V2.

In step S36, the image control unit 116 transmits the ripple image V2 generated by the drawing processing unit 115 to the projector 11, and controls the projector 11 to project the ripple image V2.

In step S37, the sound effect control unit 117 transmits a sound effect synchronized with the ripple image V2 to the speaker 14, and controls the speaker 14 to output the sound effect.

In step S38, the drawing processing unit 115 determines whether or not to finish the projection of the ripple image V2. In a case where it is determined not to finish the projection of the ripple image V2 because the predetermined time has not elapsed from the start of the projection, the processing returns to step S36, and the projection of the ripple image V2 is continued.

In contrast, in a case where it is determined in step S38 to finish the projection of the ripple image V2, the processing is finished.

With the above processing, the control apparatus 13 can use the image of spreading ripples to transmit information to the surrounding people.

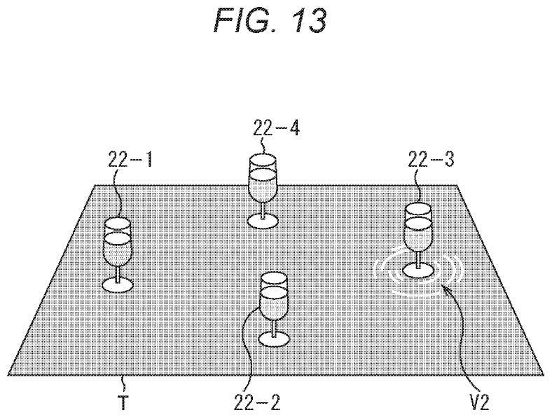

FIG. 13 is a view illustrating a use example of the ripple image V2 as described above.

In the example of FIG. 13, four glasses 22-1 to 22-4 containing liquid are placed on the table T. It is assumed that customers are sitting in front of individual glasses.

For example, in a case where the floor staff wishes to give a message to the customer using the glass 22-3 among the four customers, the mobile terminal is operated to designate the customer. The control apparatus 13 having received the information transmitted from the mobile terminal projects the ripple image V2 of spreading ripples from the position of the glass 22-3, making it possible to visually notify the customer using the glass 22-3 of information that the customer is being called by the floor staff.

In order to express the magnitude of the vibration detected by the vibration sensor, the size of the ripples in the ripple image V2 may be configured to change depending on the vibration. Furthermore, the brilliance of the ripples of the ripple image V2 may be set to be changeable depending on the illuminance so as to express the brightness in the diner or outdoors detected by the illuminance sensor.

### Modification

<Modification of Projection System Configuration>

It is possible to change as appropriate which configuration of FIG. 7 is to be implemented in which device.

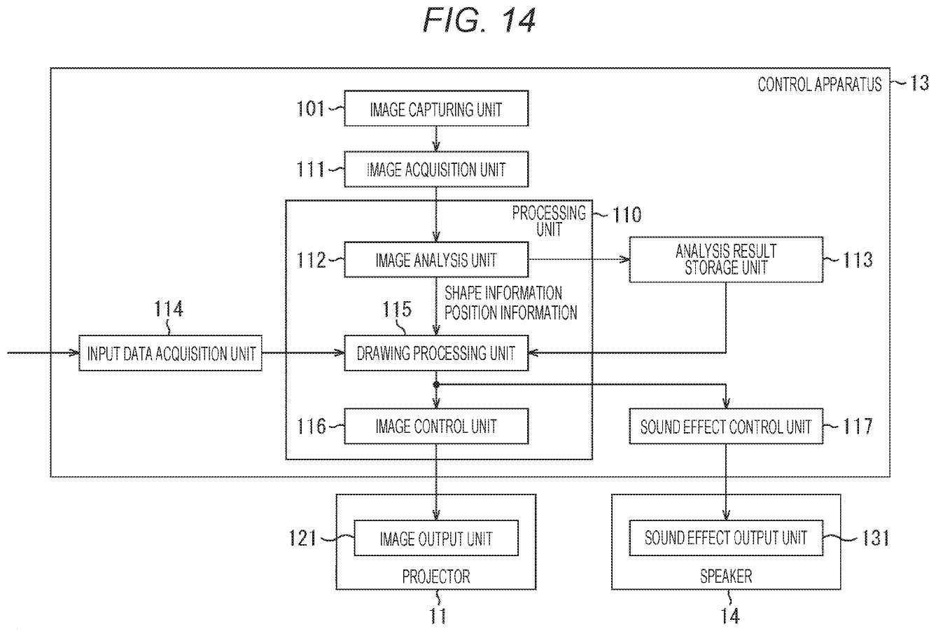

FIG. 14 is a diagram illustrating another functional configuration example of the projection system 1.

In the example of FIG. 14, an image capturing function is included in the control apparatus 13. That is, the control apparatus 13 achieves implementation of the image capturing unit 101, the image acquisition unit 111, the image analysis unit 112, the analysis result storage unit 113, the input data acquisition unit 114, the drawing processing unit 115, the image control unit 116, and the sound effect control unit 117.

In this manner, the function of the camera 12 can be incorporated in the control apparatus 13. This configuration enables, for example, use of a smartphone or a tablet terminal with a camera, as the control apparatus 13.

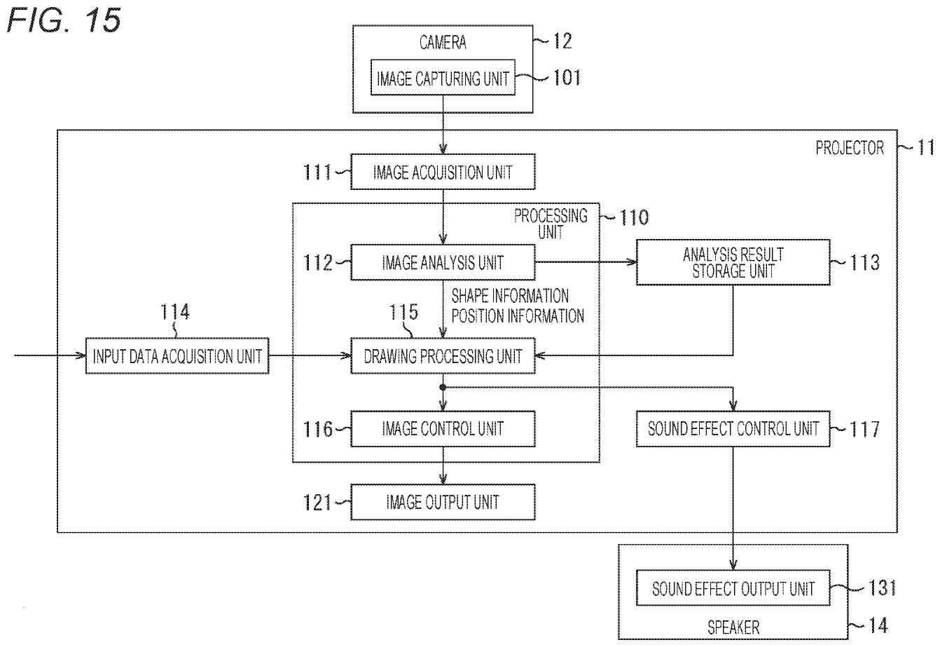

FIG. 15 is a diagram illustrating still another functional configuration example of the projection system 1.

In the example of FIG. 15, the projector 11 achieves implementation of the image acquisition unit 111, the image analysis unit 112, the analysis result storage unit 113, the input data acquisition unit 114, the drawing processing unit 115, the image control unit 116, and the sound effect control unit 117. In this manner, the functions of the control apparatus 13 can be incorporated in the projector 11.

Note that the configuration of the control apparatus 13 illustrated in FIG. 7 may be implemented on a plurality of devices. In this case, the plurality of devices to share the implementation of the configuration of the control apparatus 13 illustrated in FIG. 7 would be interconnected via a network.

The control apparatus 13 may be provided on the Internet, and communication between the control apparatus 13 and each of the projector 11, the camera 12, and the speaker 14 may be performed via the Internet.

### <Other Modifications>

While the above is an exemplary case where the target is one object, such as the house plant 21 or the glass 22, it is also allowable to set two or more objects as targets of projecting an image to which an effect according to sensor data is added.

In this case, it is possible to set an object to which an effect is to be applied to be selectable in accordance with the type of sensor data. For example, in a case where a house plant 21 and a glass 22 exist in a room, and each of the objects is captured in an image captured by the camera 12, the image analysis unit 112 analyzes the image and detects each of the objects.

The drawing processing unit 115 determines a hypothetical image regarding each of the detected objects on the basis of the detection result obtained by the image analysis unit 112. The drawing processing unit 115 determines a hypothetical shadow image for the house plant 21 while determining a ripple image representing a hypothetical vibration surface (water surface) for the glass 22.

In a case where the sensor data acquired by the input data acquisition unit 114 indicates the wind speed or the wind direction, the drawing processing unit 115 can easily express the sensor data by using the shadow of the house plant 21. Accordingly, the drawing processing unit 115 selects a hypothetical shadow image (shadow image) of the house plant 21 and controls to project the image to a position corresponding to the house plant 21 (for example, in the vicinity of the house plant 21).

In contrast, in a case where the sensor data acquired by the input data acquisition unit 114 is vibration, the drawing processing unit 115 can easily express the sensor data by using a hypothetical vibration surface of the glass 22. Accordingly, the drawing processing unit 115 selects a hypothetical image (ripple image) of a vibration surface of the glass 22, and controls to project the image to a position corresponding to the glass 22 (for example, a region within a predetermined range around the position of the glass 22).

The drawing processing unit 115 preliminarily manages table information that associates three types of information, namely, a type of sensor data, an object suitable for expressing the content of data, and an effect to be reflected on the object, and examples of the information are vibration, glass, and a ripple image, respectively. The drawing processing unit 115 selects an object and an effect corresponding to the type of sensor data on the basis of the table information, and then, controls to project an image.

The type of sensor data may correspond to the effect corresponding to the object on a one-to-one basis, or a plurality of effects may correspond to one type of sensor data. It is also allowable to associate a plurality of effects to one type of object, for example, effects according to the wind speed or rainfall may be reflected onto a soft object such as a plant, and effects according to the vibration or heat (display of evaporation etc.) may be reflected onto a liquid in a cup, etc.

<Configuration Example of Computer>

A series of processing described above can be executed in hardware or with software. In a case where the series of processing is executed by software, a program constituting the software is installed onto a computer incorporated in dedicated hardware, a general-purpose computer, or the like, from a program recording medium.

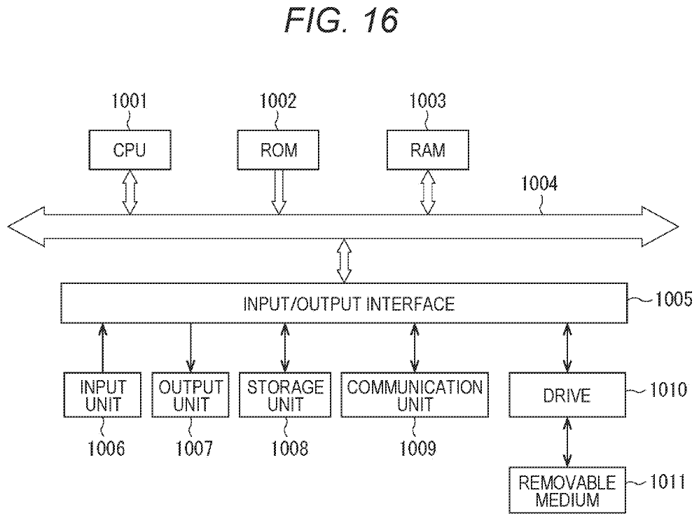

FIG. 16 is a block diagram illustrating a configuration example of hardware of a computer that executes the series of processing described above by a program.

A CPU 1001, a ROM 1002, and a RAM 1003 are connected with each other via a bus 1004.

The bus 1004 is further connected to an input/output interface 1005. The input/output interface 1005 is connected to an input unit 1006 including a keyboard, a mouse, or the like, and to an output unit 1007 including a display, a speaker, or the like. Furthermore, the input/output interface 1005 is connected to a storage unit 1008 including a hard disk, a nonvolatile memory, or the like, a communication unit 1009 including a network interface or the like, and a drive 1010 for driving a removable medium 1011.

On the computer configured as above, the series of above-described processing is executed by operation such that the CPU 1001 loads, for example, a program stored in the storage unit 1008 onto the RAM 1003 via the input/output interface 1005 and the bus 1004 and executes the program.

The program executed by the CPU 1001 is supplied in a state of being recorded in the removable medium 1011 or supplied via a wired or wireless transmission medium such as a local area network, the Internet, or a digital broadcast, for example, and installed in the storage unit 1008.

Note that the program executed by the computer may be a program processed in a time series in an order described in the present description, or can be a program processed in parallel or in required timing such as being called.

In the present description, a system represents a set of multiple constituents (devices, modules (components), or the like). In other words, all the constituents may be in a same housing but they do not have to be in the same housing. Accordingly, a plurality of apparatuses, housed in separate housings, connected via a network can be a system. An apparatus containing a plurality of modules in one housing can also be a system.

Embodiments of the present technology are not limited to the above-described embodiments but can be modified in a variety of ways without departing from the scope of the present technology.

For example, the present technology can be configured as a form of cloud computing in which one function is shared in cooperation for processing among a plurality of apparatuses via a network.

Moreover, each of steps described in the above flowcharts can be executed on one apparatus or shared by a plurality of apparatuses for processing.

Furthermore, in a case where one step includes a plurality of stages of processing, the plurality of stages of processing included in the one step can be executed on one apparatus or shared by a plurality of apparatuses for processing.

Note that effects described herein are provided for purposes of exemplary illustration and are not intended to be limiting. Still other effects may also be contemplated.

<Configuration Combination Example>

The present technology can be configured as follows.

(1)

A control apparatus including:

a space sensing data acquisition unit that acquires space sensing data regarding an object in a space obtained by sensing the space;

an external environment data acquisition unit that acquires external environment data obtained by sensing an external environment; and

a processing unit that determines an image corresponding to the object on the basis of the space sensing data and controls to project the image to which an effect corresponding to the external environment data has been added, onto the space.

(2)

The control apparatus according to (1),

in which the processing unit controls to change the image following the external environment data.

(3)

The control apparatus according to (1) or (2),

in which the space sensing data is imaging data obtained on the basis of image capturing by a camera, and

the processing unit analyzes the imaging data to identify a shape of the object, and controls to project the image corresponding to the shape of the object onto the space.

(4)

The control apparatus according to (3),

in which the processing unit analyzes the imaging data to identify a position of the object, and controls to project the image representing a virtual shadow of the object onto a position in the vicinity of the object.

(5)

The control apparatus according to (3),

in which the external environment data acquisition unit acquires the external environment data including physical quantity sensing data obtained by a physical quantity sensor that measures a physical quantity in the external environment, and

the processing unit controls to project a motion simulation image of the image based on the physical quantity sensing data, as the image.

(6)

The control apparatus according to (5),

in which the physical quantity sensing data includes information regarding wind speed or wind direction in the external environment,

the image is an image representing a virtual shadow of the object, and

the processing unit controls to project an image of the virtual shadow wavering in accordance with the information regarding the wind speed or the wind direction.

(7)

The control apparatus according to (5),

in which the physical quantity sensing data includes information regarding vibration or sound in the external environment,

the image is an image representing a virtual vibration surface of the object, and

the processing unit controls to project an image of the virtual vibration surface wavering in accordance with the information regarding the vibration or the sound.

(8)

The control apparatus according to any of (5) to (7),

in which the physical quantity sensing data includes at least any of information regarding wind speed, wind direction, strength of force, temperature, precipitation, air temperature, humidity, acceleration, light, sound, pressure, magnetism, or atmosphere.

(9)

The control apparatus according to any of (1) to (8),

in which the processing unit controls to project additional information related to the external environment data, onto a position in the vicinity of the image.

(10)

The control apparatus according to any of (1) to (9), further including

a sound effect control unit that controls to output a sound effect synchronized with the image, on the basis of the external environment data.

(11)

The control apparatus according to any of (1) to (10),

in which the external environment data acquisition unit receives the external environment data transmitted from a sensor provided in a space different from the space.

(12)

The control apparatus according to any of (1) to (11),

in which the processing unit identifies a plurality of objects existing in the space on the basis of the space sensing data, determines a plurality of images corresponding to each of the plurality of objects, and selects an image to which an effect corresponding to the external environment data is to be added, among the plurality of images, on the basis of the external environment data.

(13)

A control method including the steps of:

acquiring space sensing data regarding an object in a space obtained by sensing the space;

acquiring external environment data obtained by sensing an external environment;

determining an image corresponding to the object on the basis of the space sensing data, and

controlling to project the image to which an effect corresponding to the external environment data has been added, onto the space.

(14)

A program causing a computer to execute processing including the steps of:

acquiring space sensing data regarding an object in a space obtained by sensing the space;

acquiring external environment data obtained by sensing an external environment;

determining an image corresponding to the object on the basis of the space sensing data; and

controlling to project the image to which an effect corresponding to the external environment data has been added, onto the space.

(15)

A projection system including:

a control apparatus including

a space sensing data acquisition unit that acquires space sensing data regarding an object in a space obtained by sensing the space,

an external environment data acquisition unit that acquires external environment data obtained by sensing an external environment, and

a processing unit that determines an image corresponding to the object on the basis of the space sensing data and controls to project the image to which an effect corresponding to the external environment data has been added, onto the space; and

a projection apparatus that projects the image supplied from the control apparatus.

### REFERENCE SIGNS LIST

1 Projection system
11 Projector
12 Camera
13 Control apparatus
14 Speaker
101 Image capturing unit
111 Image acquisition unit
112 Image analysis unit
113 Analysis result storage unit
114 Input data acquisition unit
115 Drawing processing unit
116 Image control unit
117 Sound effect control unit
121 Image output unit
131 Sound effect output unit

1. A control apparatus comprising:
a space sensing data acquisition unit that acquires space sensing data regarding an object in a space obtained by sensing the space;
an external environment data acquisition unit that acquires external environment data obtained by sensing an external environment; and
a processing unit that determines an image corresponding to the object on a basis of the space sensing data and controls to project the image to which an effect corresponding to the external environment data has been added, onto the space.

2. The control apparatus according to claim 1,
wherein the processing unit controls to change the image following the external environment data.

3. The control apparatus according to claim 1,
wherein the space sensing data is imaging data obtained on a basis of image capturing by a camera, and
the processing unit analyzes the imaging data to identify a shape of the object, and controls to project the image corresponding to the shape of the object onto the space.

4. The control apparatus according to claim 3,
wherein the processing unit analyzes the imaging data to identify a position of the object, and controls to project the image representing a virtual shadow of the object onto a position in a vicinity of the object.

5. The control apparatus according to claim 3,
wherein the external environment data acquisition unit acquires the external environment data including physical quantity sensing data obtained by a physical quantity sensor that measures a physical quantity in the external environment, and
the processing unit controls to project a motion simulation image of the image based on the physical quantity sensing data, as the image.

6. The control apparatus according to claim 5,
wherein the physical quantity sensing data includes information regarding wind speed or wind direction in the external environment,
the image is an image representing a virtual shadow of the object, and
the processing unit controls to project an image of the virtual shadow wavering in accordance with the information regarding the wind speed or the wind direction.

7. The control apparatus according to claim 5,
wherein the physical quantity sensing data includes information regarding vibration or sound in the external environment,
the image is an image representing a virtual vibration surface of the object, and
the processing unit controls to project an image of the virtual vibration surface wavering in accordance with the information regarding the vibration or the sound.

8. The control apparatus according to claim 5,
wherein the physical quantity sensing data includes at least any of information regarding wind speed, wind direction, strength of force, temperature, precipitation, air temperature, humidity, acceleration, light, sound, pressure, magnetism, or atmosphere.

9. The control apparatus according to claim 1,
wherein the processing unit controls to project additional information related to the external environment data, onto a position in a vicinity of the image.

10. The control apparatus according to claim 1, further comprising
a sound effect control unit that controls to output a sound effect synchronized with the image, on a basis of the external environment data.

11. The control apparatus according to claim 1,
wherein the external environment data acquisition unit receives the external environment data transmitted from a sensor provided in a space different from the space.

12. The control apparatus according to claim 1,
wherein the processing unit identifies a plurality of objects existing in the space on the basis of the space sensing data, determines a plurality of images corresponding to each of the plurality of objects, and selects an image to which an effect corresponding to the external environment data is to be added, among the plurality of images, on a basis of the external environment data.

13. A control method comprising the steps of:
acquiring space sensing data regarding an object in a space obtained by sensing the space;
acquiring external environment data obtained by sensing an external environment;
determining an image corresponding to the object on the basis of the space sensing data, and controlling to project the image to which an effect corresponding to the external environment data has been added, onto the space.

14. A program causing a computer to execute processing comprising the steps of:
acquiring space sensing data regarding an object in a space obtained by sensing the space;
acquiring external environment data obtained by sensing an external environment;
determining an image corresponding to the object on a basis of the space sensing data, and
controlling to project the image to which an effect corresponding to the external environment data has been added, onto the space.

15. A projection system comprising:
a control apparatus including
a space sensing data acquisition unit that acquires space sensing data regarding an object in a space obtained by sensing the space,
an external environment data acquisition unit that acquires external environment data obtained by sensing an external environment, and
a processing unit that determines an image corresponding to the object on a basis of the space sensing data and controls to project the image to which an effect corresponding to the external environment data has been added, onto the space; and
a projection apparatus that projects the image supplied from the control apparatus.
